(19) United States
(12) Patent Application Publication
(10) Pub. No.: US 2009/0273427 A1
(43) Pub. Date: Nov. 5, 2009

(54) COMPACT SIZED CHOKE COIL AND FABRICATION METHOD OF SAME

(76) Inventor: Sheng-Fu Su, Luzhu Shiang (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/112,347

(22) Filed: Apr. 30, 2008

(51) Int. Cl. H01F 5/00; H01F 27/28; H01F 7/06

(52) U.S. Cl. 336/200; 336/225; 29/602.1

(57) ABSTRACT

The present invention relates to a compact sized choke coil and fabrication method of same, an enameled metal wire or metal wire enclosed with insulated material is firstly prepared, then the wire is wound into helical coil, and then a magnetic film on the helical coil is formed by sputtering a layer of magnetic substance with a thickness greater than 10⁻¹⁰ m on the surface of the helical coil, finally by electroplating, non-electroplating technologies, sol-gel method, crystal growth, or chemical vapor decomposition etc., suitable amount of magnetic substance is formed on the surface of said helical coil that has already been coated with a layer of magnetic material, and also fills the gap between and in the coil, after that, a block of compact sized choke coil is obtained.

### BACKGROUND OF THE INVENTION

1. Field of the Invention

The present invention relates to a compact sized choke coil, especially to a conductive wire enclosed with insulated film is firstly wound into helical coil, then magnetic substance is adhered as a thin coat on the helical coil's surface by the technique of thin film process, crystal growth or other chemical process, by doing that, suitable amount of magnetic substance is then attached and filled onto the overall surface of the already coated helical coil and the spaces in between, such that the resulted helical coil can be compactized, meeting the need of choke coil for compact digital devices.

2. Description of Prior Art

It is well known to public that the choke coil now available for sale, is made from electric wire that wraps around a magnetic core, but the size of the mechanical structured magnetic core is too big for the need of today's light, thin, short and compact digital products, therefore, manufacturers in this field have conducted research, in hope to produce a choke coil capable of meeting the requirement for serving the present high technical digital devices.

Taiwan Patent Publication No. 1279818 discloses a method for fabricating a choke coil, including the steps of: preparing a string of erected thin rectangularly profiled belt type conductor that has a downwardly extended section at its both ends; with the conductor's one end as starting point, winding the other end continuously towards the said starting point horizontally in circle to form horizontally erected helical coil; then bending the extended sections at the bottom of coil outward to horizontal level, this makes inner extended section extended from inside to outside, while the other extended section bended horizontally extended to outside; putting the helical coil inside a molding, with two extensions extend outside the molding; filling the molding with powdered magnetic substance, in order to enclose the helical coil so no air or gap is existed in between the coil; setting the molding to form a pair of trough on the surface of package holding coated helical coil; bending the coated coil's extended sections along the surface of coated coil after the molding is completed; and, putting the end of extended sections inside the trough formed on the package of choke coil.

However, the disclosed choke coil in said Taiwan Patent Publication No. 1279818 is obtained firstly by putting the coil in a molding, then fill the molding with powdered magnetic substance, and then apply pressing process. However, the choke coil produced according to the above method has some disadvantages. The primary concern is that, by using this natural filling and pressing method, as shown in FIG. 1, after the pressing process, the magnetic substance 2 which enveloping coil 1, obvious gap between magnetic substance 2 and coil 1 would be existed, which makes the two elements unable to completely get together, such that the volume of the produced choke coil cannot be reduced to a minimum scale. Also, the pressing process will cause damage to the coil, the final product will lead to unevenness of coil which in turn results in inaccuracy of measurement of inductance due to the damage of coil mentioned above.

Besides, because the above said conventional choke coil is produced by high mechanical pressure being applied to magnetic substance filled in molding to mold the coil, the magnetic substance used to envelope the coil will exceed the quantity actually needed, it not only is the reason why conventional coil cannot be reduced in size, it also causes increased production cost due to excess use of magnetic substance.

### SUMMARY OF THE INVENTION

Therefore, the object of present invention is to provide a compact sized choke coil, which is covered by magnetic substance as a thin film on the surface of the main body of coil, such that to protect the coil from damage occurred in conventional manufacture, and to improve the shortcoming of pressing process.

To achieve the above object, the compact sized choke coil of present invention is manufactured by: firstly preparing enameled wire or wire enclosed with insulated film, then winding the wire into helical coil, and then use sputtering method or other thin film processes, to form a layer of magnetic substance with a thickness greater than 10⁻¹⁰ m on the surface of the said helical coil, putting the magnetic substance coated helical coil into a tooling, by using the processes of electroplating, crystal growth, or chemical vapor decomposition, to form proper amount of magnetic substance envelope over the helical coil coated with magnetic substance, then a compact sized choke coil is formed.

The another object of present invention is to provide a compact sized choke coil, by utilizing sputtering or other thin film formation processes and electroplating, crystal growth or chemical vapor decomposition, not only make proper amount of magnetic substance adhere to the surface of main body of coil, the magnetic substance also fills the among the gaps of coil and the space surrounded by the coil, then makes the magnetic substance integrates with the coil completely, such that only right amount of magnetic substance is used while there is no excess of magnetic substance, thereby to reduce the cost of producing choke coil by eliminating cost of excess magnetic substance, the process can further be applied to the production of compact sized choke coil.

The above objects and other advantages of the present invention will become more apparent by describing in detail the preferred embodiment of the present invention with reference to the attached drawings.

### BRIEF DESCRIPTION OF THE DRAWINGS

FIG. 1 is a cross-sectional view showing the fabrication method of conventional choke coil as disclosed in Taiwan Patent Publication No. 1279818.

FIG. 2 is an illustrative view showing enameled wire used in present invention.

FIG. 3 is an illustrative view showing compact choke coil of present invention in helical shape.

FIG. 4 is three-dimensional view and partially exploded view showing compact choke coil of present invention adhered by magnetic substance after the substance is formed into film.

FIG. 5 is an illustrative view showing compact choke coil of present invention placed in a tooling.

FIG. 6 is a cross-sectional view showing choke coil in compact size of present invention.

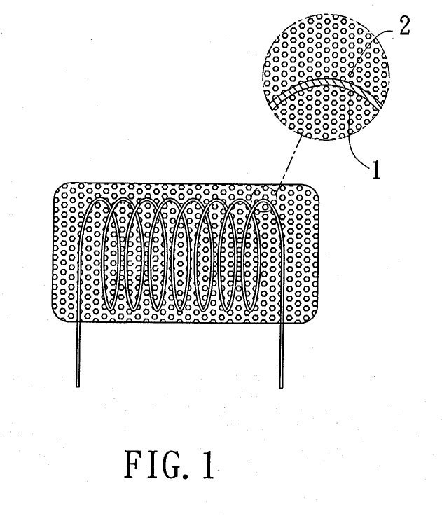

### DETAILED DESCRIPTION OF THE PREFERRED EMBODIMENTS

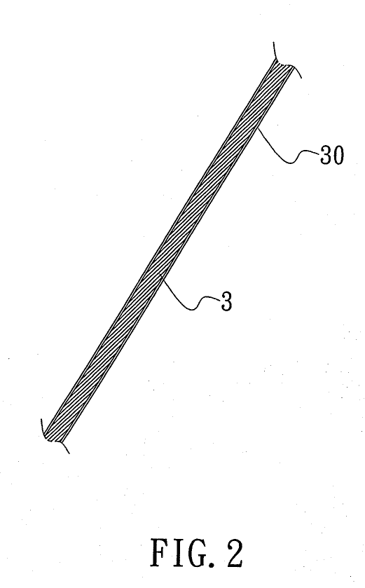

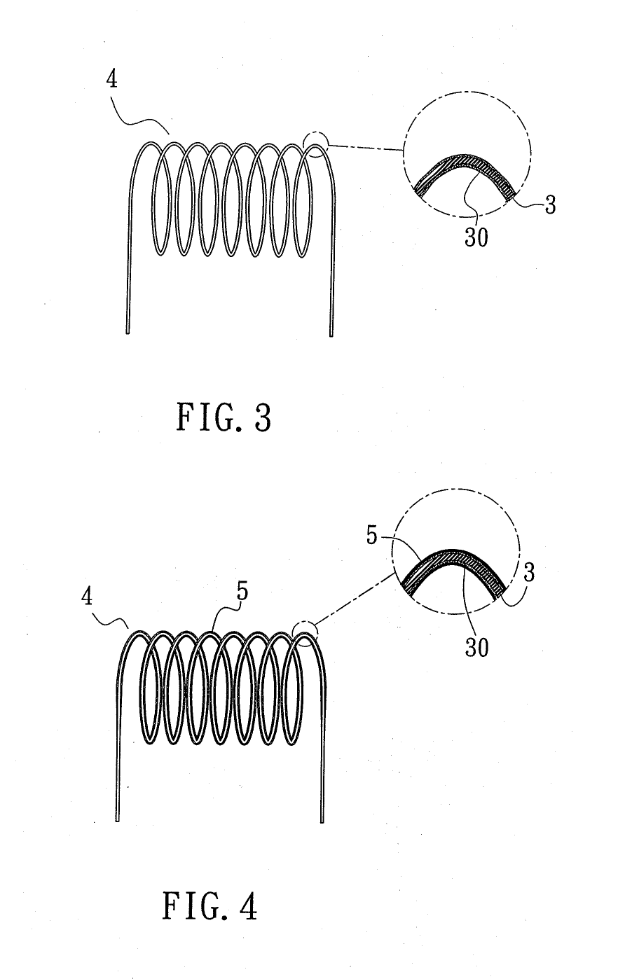

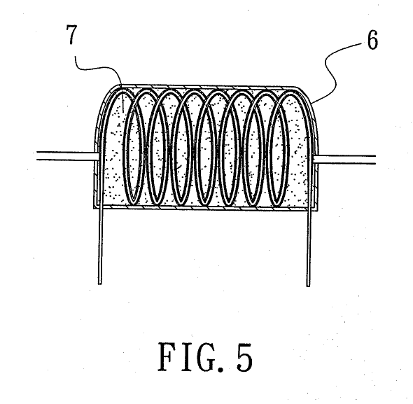

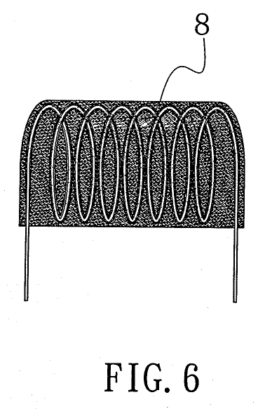

The present invention provides a compact sized choke coil, its manufacturing method consist the steps of:
1. preparing enameled wire 3, that is, a wire having its surface enclosed with polymeric insulate material 30, as main body of coil's material (as shown in FIG. 2);
2. Winding said enameled wire 3 which is made by electric wire having its surface enclosed with film of polymeric insulate material 30, horizontally into helical coil 4, the wire of helical coil is wound very densely, the better one is in circular shape (as shown in FIG. 3);
3. by using thin film formation process such as sputtering, adhere magnetic substance (such as iron, cobalt, nickel, etc.) of powder in micro scale onto surface of helical coil 4, forming a layer of thin film 5 as foundation with a thickness greater than 10⁻¹⁰ m, as shown in FIG. 4, this magnetic thin film 5 adheres intensely with the insulate material 30 enclosing onto the wire of helical coil 4;
4. put the helical coil 4 into a tooling 6 (as shown in FIG. 5), the size of the tooling must be just able to contain a proper amount of magnetic substance sufficient to enclose the whole helical coil;
5. by using the technique of electroplating, crystal growth or chemical vapor deposition, makes the inner empty space 7 of tooling 6 filled with magnetic substance, this substance not only adheres to the surface of magnetic film 5 outside the helical coil 4, but also the outer surface of helical coil 4 and the space surrounded by helical coil (as shown in FIG. 6);
6. remove the tooling 6, and a compact choke coil is produced.

As the above manufacture steps are performing, because the magnetic substance enveloping helical coil is formed through electroplating, crystal growth or chemical vapor deposition, such that the substance is formed to enclose helical coil 4, the choke coil manufactured by using this kind of technology can unify densely with its magnetic substance, and because the coil is so compact, the small quantity of magnetic substance formed by electroplating, crystal growth or chemical vapor deposition is sufficient to fill in all the inner space of helical coil 4 and wrap around the entire coil, forming a firm choke coil, thereby, the present invention do not cause the main body of coil any damage or unevenness due to the pressing process used in conventional art, it increases the functionality of electronic component.

The compact sized choke coil of present invention uses the technology of electroplating, crystal growth or chemical vapor decomposition to form magnetic material that wraps around the helical coil, the said formed magnetic material has high density and do not occupy extra space, so no large amount with excess of magnetic substance occurs, the technology therefore can be used in the production of even smaller choke coil of chip scale.

Furthermore, the compact sized choke coil of present invention not only can use the technology of electroplating, crystal growth or chemical vapor deposition to fill the magnetic substance in all the inner space of helical coil 4 and wrap around the entire coil, but also can use the technologies of non electroplating such as chemical plating, melting plating (heat immersion plating), melting injection plating, vacuum plating, cathode sputtering, ionic sputtering, strike sputtering, zinc heating method, or technology of sol-gel method.

In conclusion, since the compact sized choke coil and fabrication method of same of present invention is not disclosed and for sale previously, and its unique character and ability are more advanced, it is then believed that the present invention is an invention with progressiveness, and meets the requirement of patent application according to Patent Law of Taiwan.

Although the present invention has been described with a certain degree of particularity, the present disclosure has been made by way of example and changes in details of structure may be made without departing from the spirit thereof.

What is claimed is:

1. A compact sized choke coil, it consists of a helical coil continuously wound by electric wire, and two extensions extended from both ends of the coil as terminal; wherein the said coil is formed by an electric wire enclosed with insulated film, the surface of said coil is enclosed with magnetic substance that combines fully with the insulated film.

2. The compact sized choke coil as claimed in claim 1, wherein said magnetic substance wraps around the main body of coil and fills the inner space surrounded by the coil.

3. The compact sized choke coil as claimed in claim 1, wherein the magnetic substance which encloses the insulated film outside the wire are magnetic film, and the said magnetic film has thickness at least 10⁻¹⁰ m.

4. The compact sized choke coil as claimed in claim 1, wherein the said magnetic material is iron, cobalt, or nickel.

5. A method for fabricating compact sized choke coil including the steps of:
Preparing enameled metal wire or metal wire enclosed with insulated film as the main body of coil;
Winding said enameled metal wire or metal wire enclosed with insulated film into helical coil;
Use thin film formation process to form a thin film of magnetic substance on the surface of coil; and
By using electroplating technology to make magnetic substance filling in the gap of main body of choke coil already coated with magnetic film and the inner space surrounded by the helical coil.

6. The method for forming compact sized choke coil as claimed in claim 5, wherein the said magnetic substance that encloses the whole coil and fills the inner space surrounded by the helical coil can be obtained by the technique of crystal growth.

7. The method for forming compact sized choke coil as claimed in claim 5, wherein the said magnetic substance that encloses the whole coil and fills the inner space surrounded by the helical coil can be obtained by the technique of chemical vapor decomposition.

8. The method for forming compact sized choke coil as claimed in claim 5, wherein the said magnetic substance that encloses the whole coil and fills the inner space surrounded by the helical coil can be obtained by the technologies of non electroplating such as chemical plating, melting plating (heat immersion plating), melting injection plating, vacuum plating, cathode sputtering, ionic sputtering, strike sputtering, zinc heating method, or technology of sol-gel method.
